(19) United States
(12) Patent Application Publication
(10) Pub. No.: US 2004/0089678 A1
(43) Pub. Date: May 13, 2004

(54) Linerless dispensing cap

(76) Inventor: Douglas S. Martin, New Castle, PA (US)

Correspondence Address: PEARNE & GORDON LLP, 1801 EAST 9TH STREET, SUITE 1200, CLEVELAND, OH, 44114-3108, US

(21) Appl. No.: 10/701,237

(22) Filed: Nov. 4, 2003

Related U.S. Application Data
(63) Continuation-in-part of application No. 10/342,556, filed on Jan. 15, 2003.
Application No. 10/342,556 is a division of application No. 09/974,484, filed on Oct. 10, 2001, now Pat. No. 6,510,971.

(51) Int. Cl. B67D 3/00

(52) U.S. Cl. 222/556

(57) ABSTRACT

A dispensing cap with hinged flaps for opening and closing spoon and shake apertures in the cap end wall. The flaps, which are hinged away from the perimeter of the cap, include sealing plugs for the apertures. The plugs and apertures are formed by tooling elements on the same half of a mold to maintain very precise positioning of the plugs relative to the apertures. This precise positioning of the plugs and apertures allows them to be sized to produce a very light interference or touch fit that effectively stops moisture vapor transmission into the container and sifting of product out of the container to which the cap is fitted but, desirably, has little effect on flap opening and closing force. The sealing effectiveness of the plugs and apertures enables the cap to be used without a sealing liner for the mouth of the container.

This is a continuation-in-part of U.S. patent application Ser. No. 10/342,556, filed Jan. 15, 2003, which application is a division of Ser. No. 09/974,434, filed Oct. 10, 2001, now U.S. Pat. No. 6,510,971, the disclosure of which is incorporated herein by reference.

### BACKGROUND OF THE INVENTION

The invention relates to flap-type dispensing caps or closures for bottles, jars, and like containers.

### PRIOR ART

U.S. Pat. No. 4,693,399, now U.S. RE37,634, is an example of a screw-on two-flap dispensing cap with spoon (pour) and shake (sift) dispensing modes. This cap pioneered the use of a liner, initially carried in the cap, and sealed to the mouth of a container when the cap was screwed onto the container. The liner, before it is removed by the end user, serves to seal the container to limit moisture from passing into the container and its contents from escaping the container through unsealed parts of the cap in a manner sometimes described in the industry as “sifting”.

The referenced prior art cap and others similar to it have been provided with so-called clean-out plugs or skirts on the underside of the flap that fit into respective dispensing holes to reduce or eliminate the problem of these holes becoming plugged with the contents through use and to reduce objectionable “sifting” through the dispensing holes when the flaps are closed.

Prior art liners, while normally being effective to seal a container before being removed, pose a number of problems for cap manufacturers and packagers. For example, liner stock may be subject to degradation when exposed to elevated temperature, the wrong liner material may be loaded into a machine through human error, the liner stock can have manufacturing defects, exhibit a limited shelf life, pose splicing problems when roll stock is used, may distort into a potato chip configuration so as to not feed properly or be maintained in a cap during bulk shipment of caps, may not achieve a good seal on a bottle, may be mis-punched when formed from strips or roll stock, and may misfeed so that no liner or double liners are assembled into a cap. In sum, liners may pose the most difficult and numerous quality control problems for a cap manufacturer compared to the cap itself.

From the foregoing, it will be understood that there exists a need for an improved flap dispensing cap that can be used without a liner while limiting entry of moisture into the container and resisting unintended sifting of product when the flaps are closed. The desired cap must be capable of being mass produced with multi-cavity molds to reduce production costs and be competitive in the marketplace.

### SUMMARY OF THE INVENTION

The invention provides an improved flap style dispensing cap with a construction that enables it to be used without a liner but which has a flap plug and aperture structure that, when closed, excludes moisture and resists sifting. Additionally, the flap plug and aperture structure is advantageously capable of avoiding excessive resistance to flap opening and closing action.

One aspect of the invention involves the precise location of each flap plug or seal relative to its associated dispensing opening. This condition is obtained, according to the invention, by molding both the plug and aperture with tooling elements all mounted on the same mold side. In this manner, the related tooling elements forming the plugs and apertures can be very closely aligned with one another and their relative positions are essentially unaffected by what happens on the opposite side of the mold.

The resulting accuracy of the relative locations of the plugs and apertures is, by virtue of the invention, an order of magnitude greater than that existing in the prior art. This positional accuracy enables the manufacture of caps that can have a moisture vapor and sift-resistant seal and that can be opened or closed with moderate forces. These opening and closing forces are very important from the standpoint of the ultimate user because excessive opening force can result in broken fingernails or other frustrations; excessive closing force can be similarly troublesome. The low force associated with opening and closing of the flaps is attributable to, besides the positional accuracy of the plugs and holes, plug and aperture geometry that produces a light contact seal and full seal engagement only when a respective flap is very close to its fully closed position. A cap constructed in accordance with the invention can be used with a shrink band or wrap to secure the closure to a bottle and secure the flaps closed so as to produce a tamper-evident package.

### BRIEF DESCRIPTION OF THE DRAWINGS

FIG. 1 is a perspective view of a cap of the invention shown from the spoon opening side with the flaps open;

FIG. 2 is a perspective view of the cap shown from the shake opening side with the flaps open;

FIG. 3 is a plan view of the cap with the flaps open;

FIG. 4 is a cross-sectional view of the cap with the flaps open taken in the plane 4-4 indicated in FIG. 3;

FIG. 5 is a fragmentary cross-sectional view on an enlarged scale of a portion of the spoon opening and associated plug with the spoon flap closed;

FIG. 5A is a fragmentary view, on a much enlarged scale, of a typical sealing fit of the spoon plug and aperture;

FIG. 6 is a fragmentary cross-sectional view on an enlarged scale of a typical sift hole and associated plug with the shake flap closed;

FIG. 6A is a fragmentary view on a much enlarged scale, of a typical sealing fit of a shake plug and aperture;

FIG. 7 is a cross-sectional view of mold parts used to manufacture the disclosed cap;

FIG. 8 is an elevational view of a package, partially in section, utilizing the disclosed cap; and

FIG. 8A is an enlarged fragmentary section view of a part of the package of FIG. 8.

### DESCRIPTION OF THE PREFERRED EMBODIMENT

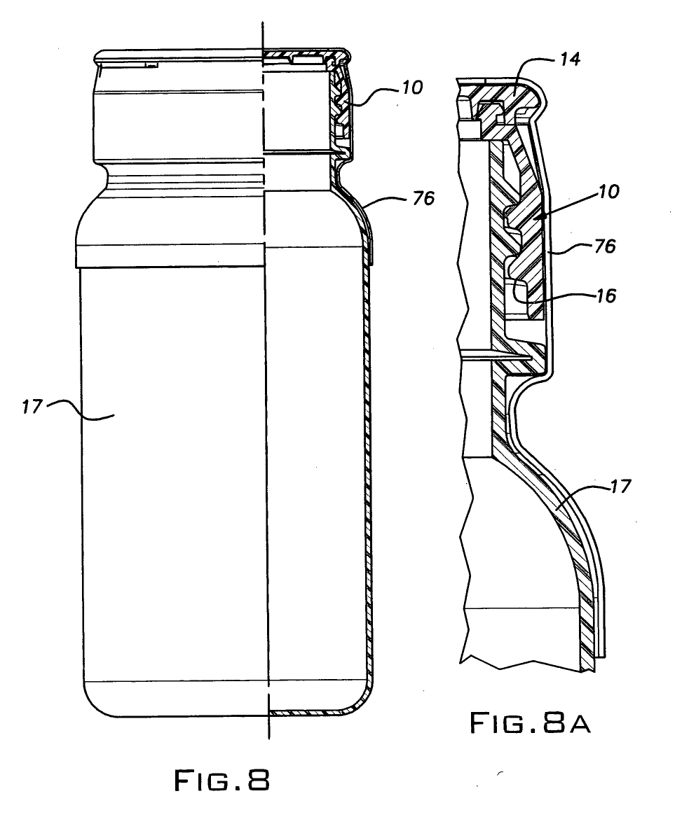

Referring now to the figures, a cap or closure is shown at 10. The cap 10 is preferably made by an injection molding process, generally known in the art. The material of the cap can be polypropylene or other suitable thermoplastic material used in the packaging industry. The illustrated cap 10 is unitary, being made in one piece, and has a short cylindrical shape. The cap 10 comprises a generally circular end wall 11, cylindrical skirt 12, and flaps 13, 14. The skirt 12 can be formed with internal threads 16 that enable the cap 10 to be screwed onto the complementary neck finish of a bottle, jar or other container 17 (FIG. 8). The illustrated version of the cap 10 has two flaps 13, 14, for dispensing dry particulate product out of the associated container 17. One flap 13 is for spooning or pouring product, and the other flap 14 is for shaking, sifting, or sprinkling product from the container.

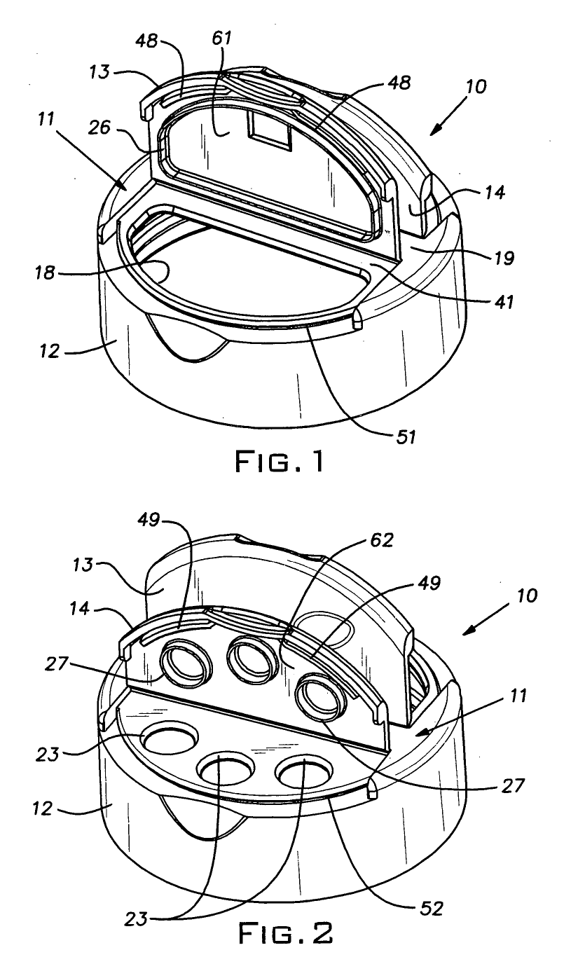

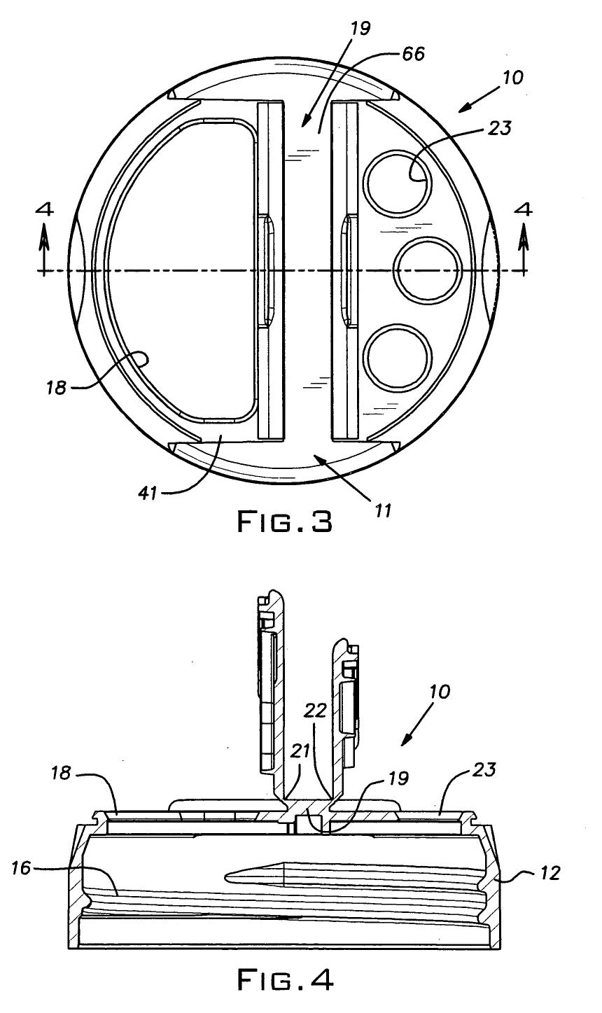

The illustrated cap 10 is a nominal 53 mm size and has a nominal wall thickness of 0.050″. As shown in FIGS. 1 and 2 and elsewhere, the end wall 11 has a relatively large spoon or pour dispensing aperture or hole 18 on one side (with reference to a chordal area 19 where the flaps 13, 14 are joined to the end wall 11 by living hinges 21, 22) and a plurality of shake dispensing apertures 23 on the other side. The spoon aperture 18 is preferably large enough to accept a teaspoon or larger spoon for spooning out product from the container 17 on which the cap 10 is fitted. Where the opening 18 is an “option” intended for pouring, for example, it can be somewhat smaller than that illustrated, but is still large compared to the wall thickness of the cap, e.g. having a dimension greater than about ten (10) times the cap wall thickness. A further option for the cap is to substitute a plurality of sift or shake holes with appropriate plugs, for the spoon aperture 18 which are normally of a size different from the sift holes 23. The sift holes or apertures 23, which can vary in number as needed or desired, are sized to efficiently and controllably dispense product from the container 17 when the container is inverted and shaken.

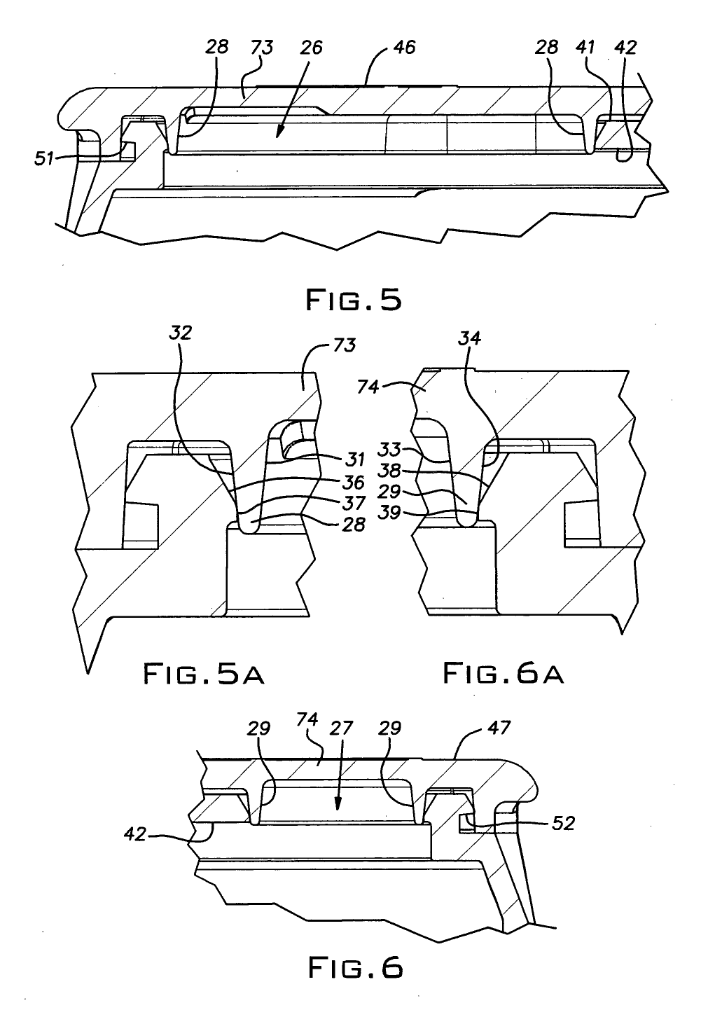

FIGS. 5, 5A, 6, and 6A illustrate details of hollow plugs 26, 27 on lower sides of the flaps 13, 14, respectively. As shown, walls 28, 29 of the plugs 26, 27 are relatively thin compared to their depth measured in a direction perpendicular to the nominal plane of the associated flap. The plug 26 for the spoon opening 18, like the spoon opening 18, is D-shaped but these elements as mentioned can have other shapes. The plugs 27 for the sift holes 23 are preferably identical to one another and are of circular or annular form. The distal ends of the plug walls 28, 29 are rounded and the interior and exterior surfaces 31, 32 and 33, 34 of the walls are slightly divergent, each about 4° from a line perpendicular to the plane of the respective flap 13, 14. Alternatively, the walls 33, 34 can be perpendicular to the plane of the respective flap.

The dispensing apertures or holes 18, 23 are bounded by surfaces 36, 38 characterized by exaggerated draft-like configurations so that the apertures are widest adjacent an upper surface 41 of the end wall 11. The apertures 18, 23 adjacent an inner surface or underside 42 of the end wall 11 have aperture surfaces 37, 39 more closely aligned or parallel with the axis of the cap at the center of the skirt 12. These narrow surfaces 37, 39 are the areas against which the plugs 26, 27 seal.

The hinges 21, 22 are parallel to one another and lie along chordal lines relative to the circular end wall 11 when seen in plan view. The hinges 21, 22 are situated above the plane of a main area of the end wall 11 so they are adjacent the plane formed by upper surfaces 46, 47, of the flaps 13, 14 when the latter are closed. The flaps 13, 14 are releasably held in closed positions by depending catches 48, 49 that interact with complimentary receiving areas 51, 52 on the end wall 11.

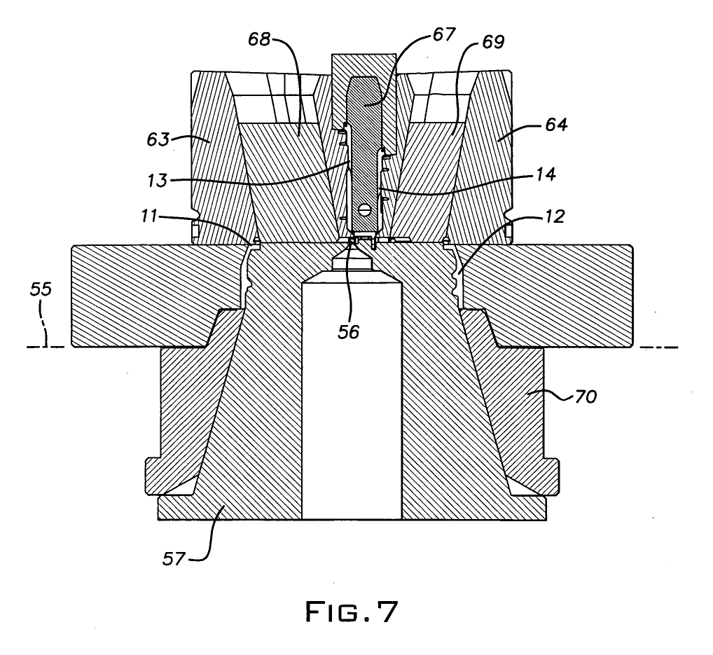

In FIG. 7 there is shown a somewhat schematic arrangement of a mold for producing the illustrated cap 10. The mold parts are shown in a fully closed position where they define the mold cavity. The mold apparatus separates or opens across a plane designated by the numeral 55 in FIG. 7. Mold parts below the plane 55 are stationary on a mold half or platen (not shown) while mold parts above the plane 55 are carried on the moveable mold half or platen (not shown). Molten plastic is injected through a gate 56 into the mold cavity at the underside of the end wall 11 in the chordal area 19 that the hinges 21, 22 overlie. The cap end wall 11 and skirt 12 are formed internally by a threaded core 57. The principal areas of the upper surface 41 of the end wall and undersides 61, 62 of the flaps 13, 14 are formed by a pair of main slides 63, 64. An upper surface 66 of the chordal area 19 and upper surfaces 46, 47 of the flaps 13, 14 are formed by a center flap form 67. Auxiliary slides or sub-slides 68, 69 carried in the main slides 63, 64 form the perimeter or boundary surfaces 36, 37 and 38, 39 of the dispensing apertures 18, 23. The auxiliary slide 69 additionally forms portions of the upper surface 41 of the end wall surrounding the shake apertures 23.

Study of FIG. 7 and the preceding discussion reveals that the plugs 26, 27 on the underside of the flaps 13, 14 are formed by the respective main slides 63, 64. The cap 10 is released from the mold by first withdrawing the auxiliary slides 68, 69 upwardly in the orientation of FIG. 7 by linkages or cams, for example, and then withdrawing the main slides 63, 64 (horizontally in FIG. 7) by linkages or cams, for example, and then by separating the platens at the plane 55. A stripper ring 70 forces the cap off the threaded core 57 in a known manner.

It will be seen that the boundaries or peripheries of the dispensing apertures 36, 37 and 38, 39 and their respective plugs 26, 27 are formed by tooling elements of the mold situated on the same mold half or platen. This arrangement is unusual for caps of the general type described, i.e. where the flap hinge is spaced inwardly from the periphery of the closure and the flap is molded within a projection of the plan view of the end wall 11. For example, the flaps in the illustrated case are molded at 90° to the plane of the end wall 11. Normally, in the prior art the apertures are formed by tool elements on one part or platen and the plugs are formed on the other mold part or platen. The disclosed arrangement where the plugs 26, 27 and apertures 18, 23 are formed by elements on the same mold part or platen yields much greater precision in the relative positions of the plugs and apertures in the molded product. This positional accuracy enables the plugs 26, 27 and apertures 18 and 23 to be sized for a very light interference or touch fit of about 0.0015 to 0.004″, for instance, interference across a diameter of a circular plug or in the case of the spoon opening 18 between opposite sides of the opening.

The light or touch fit between the plugs 26, 27 and apertures 18, 23 achieved by the invention is advantageous because it does not significantly affect the opening and closing forces required to open or close a flap 13, 14 over that required to release or reset a catch 48, 49. Moreover, influence of opening and closing action force by the plugs 26, 27 and apertures 18, 23 is reduced where the relatively large draft or relief angle of the surfaces 36, 38 exists for a major part of the vertical height of the aperture. There is essentially no interference between the plug and aperture until the part of a plug distal from the flap engages the actual sealing area or surface 37, 39 of an aperture. Each sealing area 37, 39, by design, is preferably substantially less in height than the height or thickness of the end wall 11. Sealing occurs only when the catch 48 or 49 is nearly locked onto its receiving area or structure 51 or 52 on the end wall. At other positions of a flap, there is essentially no frictional drag between the flap plugs 26, 27 and apertures 18, 23. The hollow construction of the plugs 26, 27 and their relatively thin walls, where their wall thickness is several times less than their height, reduces the forces required to move the plugs into their respective apertures 18 and 23 since the plugs are capable of deforming slightly to conform to the size and relative position of their respective apertures.

FIGS. 5 and 6 illustrate a manner by which the relatively “blind” pockets of the mold that form the plugs 26, 27 are assured to be substantially filled with the plastic cap material and by which voids due to trapped gas are substantially avoided. Areas of the mold corresponding to local thin wall areas 73, 74 of the flaps adjacent the pockets forming the plugs 26, 27 remote from the gate 56 serve as flow restrictions upstream from those portions of the plug cavity areas remote from the gate so that plastic tends to flow into and through the plug cavity areas before plastic flows completely past a plug cavity. This allows gas to escape a plug cavity before it is closed off by the lead edge of the main flow of plastic through the main part of the flap cavity. In the illustrated case, as shown in FIG. 7, the flaps 13, 14 are molded at 90° to the plane of the end wall 11.

FIGS. 8 and 8A illustrate a package formed by the cap 10 in combination with the bottle 17 and a shrink wrap band or label 76. The band 76, in the illustrated example, is relatively short in comparison to the height of the bottle 17, but it will be understood that it can extend along the full height of the bottle to serve as a full label. The band 76, as is known in the art, can be printed with advertising and/or directions for use of the contents of the bottle 17. The band 76, when shrunk by application of heat or other medium, cups over the outer periphery of the flaps 13, 14 to prevent them from accidentally opening or being deliberately opened without evidence of the same in the form of a fracture or tearing of the band.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A thermoplastic injection molded one-piece closure for dispensing dry particulate material, the closure having an end wall bounded by a periphery and having a relatively large opening and/or a plurality of shaker openings, a flap or flaps adapted to respectively close said opening or openings, the flap or flaps each being integrally connected to the end wall by a respective living hinge spaced inward from the periphery of the end wall, each flap having a lower side and a hollow plug on the lower side for each opening in the end wall associated with the flap, the hollow plug or plugs each being arranged to seal an associated opening when the respective flap is in a closed position adjacent the end wall and permit dispensing through the associated opening when the respective flap is in an open position where it is rotated about the associated hinge from said closed position, the plugs and apertures being precision molded relative to one another by surfaces carried on the same mold side.

2. A closure as set forth in claim 1, wherein said plug or plugs are dimensioned to provide a touch fit seal with their associated apertures.

3. A closure as set forth in claim 1, wherein said aperture or apertures have tapered surface boundaries such that the apertures are smaller in size with distance from an upper side of the end wall whereby the plugs are adapted to avoid frictional resistance with said apertures until a respective flap is near its closed position.

4. A closure as set forth in claim 3, wherein said end wall has an inner surface and said aperture or apertures have a minimum size adjacent said inner surface of said end wall.

5. A closure as set forth in claim 1, wherein said aperture or apertures are configured to seal between inner and outer surfaces of said end wall and such sealing is effected in an area with a height that is substantially smaller than the thickness of said end wall.

6. A closure as set forth in claim 1, including a cylindrical skirt depending from said end wall, said skirt being internally threaded for screwing onto a complimentarily shaped neck finish of a container.

7. A closure as set forth in claim 1, wherein said plug or plugs are hollow wall structures extending from a respective flap in a substantially perpendicular direction from said flap.

8. A closure as set forth in claim 1, wherein said plug or plugs are hollow formations having relatively thin walls, said walls having interior and exterior tapers.

9. A closure as set forth in claim 8, wherein said plug or plugs have a length that is several times the thickness of their wall.

10. A closure as set forth in claim 1, wherein the length of said plug or plugs is approximately equal to or slightly greater than the wall thickness of the end wall.

11. A package comprising a bottle having a neck finish, a cap comprising a thermoplastic injection molded one-piece closure for dispensing dry particulate material, the closure having an end wall bounded by a periphery and having a spoon opening and/or a plurality of shaker openings, a flap or flaps adapted to respectively close said opening or openings, the flap or flaps each being integrally connected to the end wall by a respective living hinge spaced inward from the periphery of the end wall, each flap having a lower side and a hollow plug on the lower side for each opening in the end wall associated with the flap, the hollow plug or plugs being arranged to seal an associated opening when the respective flap is in a closed position adjacent the end wall and permit dispensing through the associated opening when the respective flap is in an open position where it is rotated about the associated hinge from said closed position, the plug or plugs and aperture or apertures being precision molded relative to one another by surfaces carried on the same mold side, the cap having a peripheral portion structured to couple with the bottle neck finish, and a shrink wrap band applied to the exterior of the cap and bottle and shrunk in position to envelope at least portions of the flap or flaps of the cap and maintain the same in a closed position until broken.

12. A method of making one-piece dispensing closures comprising providing tooling elements that, when closed, collectively form a mold cavity defining the shape of the closure, the tooling elements being assembled on one or the other of a pair of platens, one platen being movable relative to the other, the cavity being arranged to form an end wall with at least one dispensing aperture and at least one flap integrally hinged to the end wall at a location inwardly from a periphery of the end wall and having a plug registerable with each aperture as a pair when the flap is closed over the end wall, each aperture and plug pair being formed by tooling elements on a common platen whereby precise location of each plug with respect to its paired aperture is achieved.

13. A method as set forth in claim 12, wherein the mold cavity tooling elements are configured to produce a touch seal between the plug and aperture.

14. A method as set forth in claim 12, wherein the mold cavity tooling elements are configured to form the plug or plugs as thin wall hollow structures open at ends distal from the respective flap or flaps.
